(19) United States
(12) Patent Application Publication
(10) Pub. No.: US 2004/0261820 A1
(43) Pub. Date: Dec. 30, 2004

(54) Dishwashing machine having a water vapor recovery line and method for washing articles

(76) Inventors: Lee J. Monsrud, Inver Grove, MN (US); John P. Furber, St. Paul, MN (US); Eddie D. Sowle, Woodbury, MN (US)

Correspondence Address: MERCHANT & GOULD PC, P.O. BOX 2903, MINNEAPOLIS, MN, 55402-0903, US

(21) Appl. No.: 10/610,330

(22) Filed: Jun. 30, 2003

(51) Int. Cl. B08B 15/00

(52) U.S. Cl. 134/10; 134/25.2; 134/26; 134/34; 134/95.2; 134/102.3; 134/104.2; 134/107

(57) ABSTRACT

The washing chamber includes a housing, a washing chamber interior for spray application of wash water and rinse water, and a water vapor vent for removal of water vapor from the washing chamber interior. The water holding tank is provided for holding wash water and rinse water from the washing chamber. The water vapor recovery line extends from the water vapor vent to an air and liquid water discharge. The water vapor recovery line comprises a condensing region for condensing water vapor present in the condensing region. A method for operating a dishwashing machine is provided.

### FIELD OF THE INVENTION

The invention relates to a dishwashing machine having a water vapor recovery line for the recovery of water vapor from the dishwashing machine, and to a method for washing articles in a dishwashing machine. In particular, the invention relates to the use of heat transfer by direct contact with liquid water to condense the water vapor. The water vapor and air mixture inside the dishwashing machine can be recirculated back to the dishwashing machine or replaced with ambient air from outside the dishwashing machine.

### BACKGROUND OF THE INVENTION

Commercial automated dishwashers have been used for many years in a variety of different locales to provide automated cleaning of cookware, silverware, dishware, glasses or other ware. Regardless of whether the dishwasher in question is a simple batch loading dishwasher or a complex multi-stage machine, there is an on-going problem with heated water vapor escaping the machine at the end of a cleaning program. Heat and humidity that comes into direct contact with the kitchen personnel and generally reduces comfort of the kitchen environment. In addition, having too much humidity in the air can create other problems often found in humid environments including growth of mold and deterioration of the facility.

Commercial dishwashing machines can heat water or utilize very hot water from other sources, especially in the final rinse stage, to help ensure cleaning and sanitation. Commercial dishwashers are often classified as either high temperature machines or as low temperature machines, based on final rinse water temperature. The high temperature machines generally have a final rinse water temperature of at least about 180° F., and the low temperature machines generally have a final rinse water temperature of about 160° F. High temperatures are used to ensure adequate sanitization of the articles being cleaned. The high temperature rinse allows for one-step sanitization whereas the low temperature rinse is typically accompanied by an additional chemical (chlorine, peracid, etc.) in a sanitization step. In either situation, hot ware and significant volumes of heated, highly humidified air are created in the dishwashing machine, particularly as a result of the final rinse, which is typically the hottest step in the dish or warewashing process.

Direct contact with hot, humid air can pose safety problems. The humidity can cause significant safety problems for people who wear glasses and/or contact lenses. The hot, humid air can irritate people without eyewear as well. Significant amounts of heated water vapor are put into the room environment can strain air conditioning systems.

One way to address the problems associated with hot, humid air from commercial dishwashing machines it to use a vent hood to capture the hot, humid air escaping from the dishwasher upon opening. A drawback to this method is that the hot, humid air contacts environmental air as the dishwasher door is opened and the hood removes only a portion of the hot, humid air. As a result, some heat and humidity is transferred to the immediate environment. While the hood will draw the hot, humid air up and away from the dishwasher, it may fail to completely protect the operator from contact with heat and humidity. Hoods are often very large and noisy and they can be expensive because they are run continuously exhausting heat during winter months and exhausting conditioned air during summer months. Furthermore, such a system requires venting to the exterior of the building, and condensation within the vent may pose a problem.

Numerous designs have been provided for dealing with the hot, humid air from commercial dishwashing machines. For example, see U.S. Pat. No. 6,170,166 to Johansen et al. and U.S. Pat. No. 3,789,860 to Katterheinrich et al. Dishwashing machines designed to handle the steam created by using the dishwashing machines are described by European Publication No. EP 0 753 282 A1 and European Publication No. EP 0 721 762 A1.

### SUMMARY OF THE INVENTION

A dishwashing machine is provided according to the invention. The dishwashing machine includes a washing chamber, a water holding tank, and a water vapor recovery line. The washing chamber includes a housing, a washing chamber interior for spray application of wash water and rinse water, and a water vapor vent for removal of water vapor from the washing chamber interior. The water holding tank is provided for holding wash water and rinse water from the washing chamber. The water vapor recovery line extends from the water vapor vent to an air and liquid water discharge. The water vapor recovery line comprises a condensing region for condensing water vapor present in the condensing region. The condensing region comprises a plurality of spray nozzles for spraying water within the condensing region.

An alternative embodiment of a dishwashing machine is provided according to the invention. The dishwashing machine includes a washing chamber, a water holding tank, and a water vapor recovery line. The washing chamber comprises a housing, a washing chamber interior for spray application of wash water and rinse water, and a water vapor vent for removal of water vapor from the washing chamber interior. The water holding tank is provided for holding wash water and rinse water from the washing chamber. The water vapor recovery line includes a water tank comprising a water bath, a water vapor conduit, an air discharge from the water tank, and a fan. The water vapor conduit comprises a first end and a second end, wherein the first end extends from the water vapor vent and the second end extends into the pool of water. The fan is provided for drawing water vapor from the washing chamber interior to the water holding tank. The fan can be provided within the water vapor conduit. Alternatively, the fan can be provided in the air discharge from the water tank.

A method for operating a dishwashing machine is provided according to the invention. The method includes steps of washing articles in a washing chamber interior of a washing chamber by spray application of wash water and rinse water onto the articles, drawing water vapor from the washing chamber interior into a water vapor recovery line and condensing at least a portion of the water vapor at a water vapor flow rate of at least about 45 ft³/min, and removing the articles from the dishwashing enclosure.

### BRIEF DESCRIPTION OF THE DRAWINGS

FIG. 1 is a perspective view of a dishwashing machine having a water vapor recovery line according to the principles of the invention wherein a portion of the water vapor recovery line is removed for illustration.

FIG. 2 is a perspective view of the dishwashing machine of FIG. 1 having an alternative embodiment of a water vapor recovery line according to the principles of the invention, wherein a portion of the water vapor recovery line is removed for illustration.

FIG. 3 is a perspective view of an alternative embodiment of a water vapor recovery line according to the principles of the invention.

FIG. 4 is a perspective view of an alternative embodiment of a water vapor recovery line according to the principles of the invention.

FIG. 5 is a perspective view of an alternative embodiment of a water vapor recovery line according to the principles of the invention.

FIG. 6 is a diagram view of an alternative embodiment of a water vapor recovery line according to the invention.

FIG. 7 is a diagram view of an alternative embodiment of a dishwashing machine having a water vapor recovery line according to the principles of the invention.

FIG. 8 is a diagram view of an alternative embodiment of a dishwashing machine having a water vapor recovery line according to the principles of the invention.

FIG. 9 is a diagram view of an alternative embodiment of a dishwashing machine having a water vapor recovery line according to the principles of the invention.

### DETAILED DESCRIPTION

The dishwashing machine according to the invention provides for the transfer of water vapor from a washing chamber into a water vapor recovery line for condensation of at least a portion of the water vapor. The dishwashing machine can be operated to include a condensation cycle for the removal of water vapor from the washing chamber after a rinse cycle. The condensation cycle can be operated so that it is not necessary to use a hood to capture heat and humidity escaping the washing chamber. By condensing water vapor from the dishwashing machine, it is possible to avoid having a cloud of vapor escape when the dishwashing machine is opened to the environment by, for example, opening the door.

The water vapor and air mixture inside the dishwashing machine can be condensed and recirculated back to the dishwashing machine or condensed and replaced with ambient air from outside the dishwashing machine. In addition, the dishwashing machine can include a combination of recirculated and replaced air after a condensation cycle. It is believed that by recycling the water vapor to subsequent washing steps, there can be a savings of energy and water usage.

The dishwashing machine can be used to wash and rinse any article that fits within the dishwashing enclosure and is capable of being washed in a dishwashing machine. Exemplary articles that are commonly washed and rinsed in a dishwashing machine include dishware, cookware, silverware, glasses, cups, cutting boards, and other ware items.

The dishwashing machine according to the invention can be referred to as a warewashing machine. The dishwashing machine can be provided for commercial use and/or for residential use. It is expected that the dishwashing machine will find particular application in commercial, batch-loading operations that are commonly found in restaurants. Commercially available dishwashing machines that can be modified to include the features of the invention are available under the names Hobart AM-14 and Hobart FLT. The dishwashing machine can be used commercially without a hood that would otherwise be used to pull moist air escaping from the dishwashing machine and ambient air within the kitchen to outside. By removing hoods found in many commercial kitchens above commercial dishwashing machines, it is expected that savings in air conditioning and heating costs will be realized and additional space will become available for other uses.

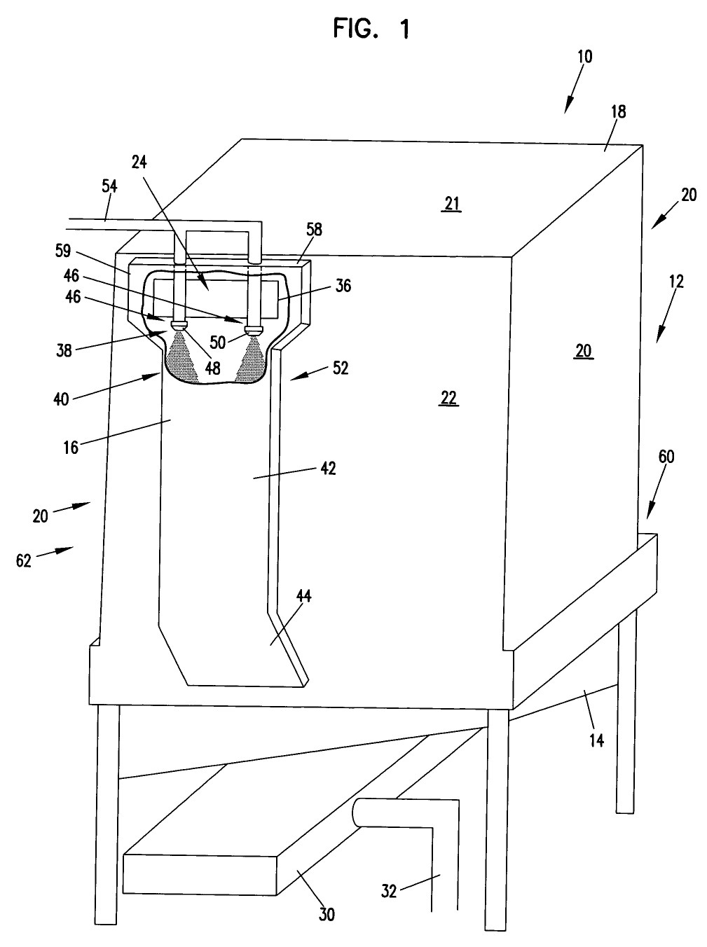

Now referring to FIG. 1, a dishwashing machine according to the principles of the invention is shown at reference number 10. The dishwashing machine 10 includes a washing chamber 12, a water holding tank 14, and a water vapor recovery line 16. The washing chamber 12 and the water holding tank 14 can have a general structure similar to that found on conventional dishwashing machines. In addition, conventional dishwashing machines can be adapted or retrofit to include the water vapor recovery line 16.

The washing chamber 12 includes a housing 18 having sidewalls 20, a top wall 21, and a back wall 22. In general, it is expected that at least one of the sidewalls 20 can be moved to access the washing chamber interior 24 where articles are washed and rinsed. Although the water vapor recovery line 16 is shown located on the back wall 22, it should be understood that the water vapor recovery line 16 can be provided on any of the walls as long as it is structured according to the invention to provide for the removal of water vapor from the washing chamber interior 24.

The washing chamber 12 includes a vapor vent 36 that allows water vapor to flow from the washing chamber interior 24 into the water vapor recovery line 16. The vapor vent 36 should have a size sufficient to allow the water vapor to flow at a desired rate in order to promote evacuation of water vapor from the washing chamber interior 24 in a desired amount of time. In general, it is desirable to provide a relatively fast evacuation of water vapor from the washing chamber interior 24 in order to decrease the length of time between the end of a rinsing cycle and the unloading of articles from the dishwashing machine 10. In the case of a commercial dishwashing machine, it is expected that articles will be washed relatively frequently and it will be desirable to minimize the amount of down time between washings. The venting time can be provided at less than about 40 seconds, less than about 30 seconds, less than about 20 seconds, and less than about 15 seconds, depending upon the amount of water vapor or air that can be moved out of the washing chamber 12. In general, it is desirable to remove or replace the volume within the washing chamber about three times in order to sufficiently remove the water vapor in order to reduce clouding when the dishwashing machine is opened. It is expected that most commercial dishwashing machines will have a washing chamber interior having a volume of between about 9 ft³ and about 14 ft³. By providing a volume flow rate of air of at least about 45 ft³/min, it is believed that the dishwashing machine will be sufficiently evacuated after about 40 seconds so that when the dishwashing machine is opened, one does not observe a large cloud of water vapor exiting the dishwashing machine. The volume flow rate can be at least about 60 ft³/min to provide an evacuation time of less than about 30 seconds. For such sized dishwashing machines, it is expected that the volume flow rate will be less than about 130 ft³/min because evacuation times need not be less than 10 seconds.

The water vapor recovery line 16 includes a spray nozzle arrangement 38 that generates a spray of water 40. The spray of water 40 helps drive the flow of water vapor out of the washing chamber interior 24 and into the water vapor recovery line 16, and provides heat transfer from the water vapor to the spray of water 40 to help condense the water vapor. The applicants have developed techniques for increasing the volume flow rate in order to decrease the evacuation time.

The water vapor recovery line 16 includes a condensing region 42 and a discharge region 44. The condensing region 42 is that portion of the water vapor recovery line 16 where at least a portion of the water vapor condenses. As the water vapor condenses, the liquid water provided from the water vapor and the spray of water 40 collects in the discharge region 44. In the case of a water vapor recovery line constructed to recycle the condensed water vapor and the spray of water 40, the discharge region 44 can be provided so that it recycles the water into the water holding tank 14. The water holding tank 14 can contain water that can be used by the dishwashing machine 10 to wash articles provided within washing chamber interior 24. An advantage of recycling the water vapor is that heat from the water vapor can be recovered and used in a subsequent washing step. In addition, recycling water conserves water. Although FIG. 1 shows the discharge region 44 configured to recycle water to the water holding tank 14, the water can be directed to the drain pan 30 if it is desired to drain the water rather than to recycle the water. In any event, it should be understood that the water holding tank 14 is constructed so that when water exceeds a certain level, the water overflows the water holding tank 14 and flows into the drain pan 30 and down the drain 32.

The spray nozzle arrangement 38 can be constructed so that the spray of water 40 helps drive the water vapor out of the washing chamber interior 24. The spray of water 40 can be arranged so that water is not directed through the vapor vent 36 and into the washing chamber interior 24. As shown in FIG. 1, the spray nozzle arrangement 38 can include a plurality of spray nozzles 46 that direct the spray of water 40 away from the vapor vent 36. The spray of water 40 can be provided in a generally downward direction. The plurality of spray nozzles 46 can be located below the vapor vent 36 to ensure that liquid water is not directed into the washing chamber interior 24.

As shown in FIG. 1, the spray nozzle arrangement 38 includes a first spray nozzle 48 and a second spray nozzle 50. The plurality of spray nozzles 46 can be referred to as “driver nozzles” when they are provided to generate flow of the water vapor out of the washing chamber interior 24 and into the water vapor recovery line 16. The plurality of spray nozzles 46 can generate a spray pattern 52 that causes water vapor to move out of the washing chamber interior 24 and down the water vapor recovery line 16 toward the discharge region 44. In addition, it is desirable for the spray pattern 52 to provide a desired level of coverage across the interior of the condensing region to provide for heat transfer between the water vapor and the water spray. It is believed that increasing the surface area of the liquid water resulting from the spray will help increase the rate of condensation of the water vapor.

The spray nozzle arrangement 38 includes a water delivery line 54 that provides water to the spray nozzle arrangement 38. Although the water delivery line 54 is shown extending through the top 58 of the water vapor recovery line 16, it should be understood that the water delivery line 54 can be provided extending through the sides or bottom or back 59 of the water vapor recovery line 16.

To assist the flow of water vapor and air out of the washing chamber interior 24, air from the exterior environment can be allowed to flow into the washing chamber interior 24. Most commercially available dishwashing machines include a gap 60 adjacent the sidewalls 20 that allows cool air to flow from the environment into the washing machine interior 24. Additional air vents can be provided to assist the flow of air from outside the dishwashing machine to the washing chamber interior 24. The water vapor recovery line 16 shown in FIG. 1 can be characterized as a recirculation configuration 62 because the water vapor and air mixture inside the washing chamber interior 24 is recirculated through the water vapor recovery line 16 and the drier water vapor and air mixture is returned to the washing machine interior 24. Because of the presence of the gap 60, it is expected that there will be a mixture of both recirculation and replacement of the water vapor and air mixture located inside the washing machine interior 24. Additional air vents can be provided in the walls of the washing chamber to assist in the level of replacement of the water vapor and air mixture located in the washing chamber interior 24.

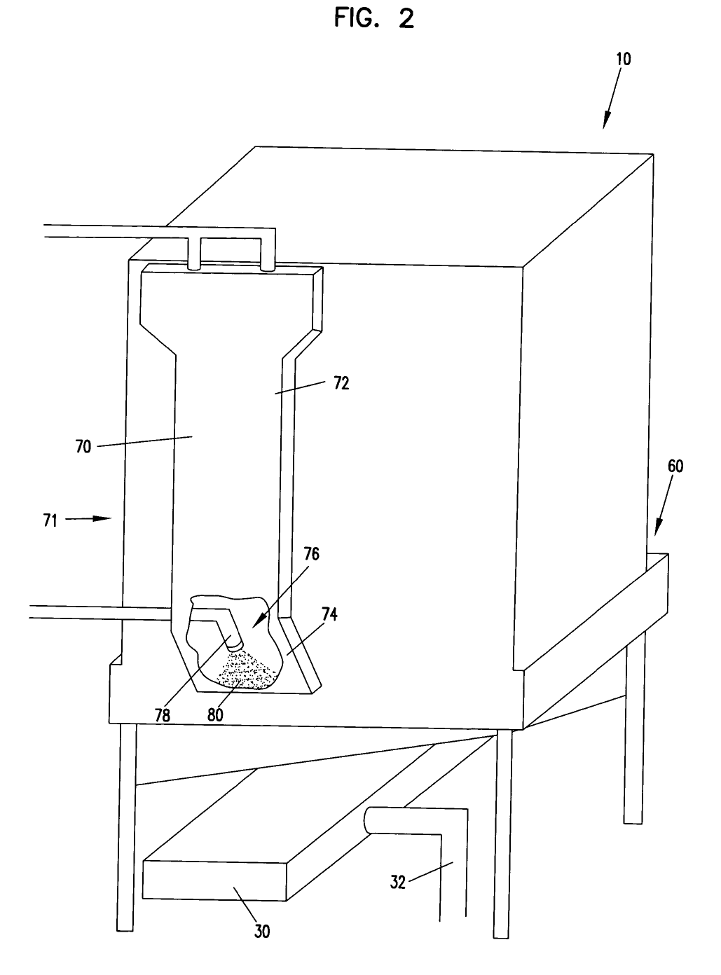

Now referring to FIG. 2, the dishwashing machine 10 is shown having an alternative water vapor recovery line 70. The water vapor recovery line 70 includes a condensing region 72 and a discharge region 74. Water vapor can flow from the washing chamber interior through a vapor vent in the washing chamber interior and into the water vapor recovery line 70 in an arrangement similar to that shown in FIG. 1. A spray nozzle arrangement can be provided for driving the water vapor out of the washing chamber interior and into the water vapor recovery line 70 and condensing the water vapor to liquid water. The spray nozzle arrangement can include a driver spray nozzle arrangement similar to the spray nozzle arrangement 38 shown in FIG. 1 and a condenser spray nozzle arrangement 76.

The condenser nozzle arrangement 76 can be provided to help increase the surface area or contact area between the liquid water and the water vapor in order to promote heat transfer and condensation of the water vapor. By increasing the volume flow rate of water vapor and air out of the washing chamber interior, it may be desirable to increase the contact area between the liquid water and the water vapor in order to ensure that the air leaving the discharge region 74 has been desirably reduced in water vapor content. The condenser nozzle arrangement 76 can include a condenser nozzle 78 that generates a fine spray of liquid water 80.

Spray nozzles that can be used according to the invention can be generally characterized as “driver nozzles” and/or “condenser nozzles” depending upon their primary function. In general, driver nozzles are provided to create a flow of vapor from the washing chamber interior through the water vapor recovery line. The driver nozzles can be selected so that the spray pattern helps drive water vapor flow in the desired direction. Accordingly, the angle of spray and the droplet size can be controlled to provide the desired level of water vapor flow. In order to direct water vapor flow in a desired direction, the driver nozzles can be selected to provide an angle of spray of less than about 90°. Although a jet stream of about 1° or less can be used to create flow of water vapor, it is expected that such a jet stream will result in a greater amount of waste water than a driver nozzle providing an angle of spray that is greater than 1°. In general, the driver nozzles can be selected to provide an angle of spray of between about 20° and about 90°. In addition, the driver nozzles can be selected to provide a droplet size of between about 200 μm VMD and about 4,000 μm VMD. In general, condenser nozzles are provided to increase the surface area of the liquid water and thereby enhance heat transfer between the water vapor and the liquid water. It is desirable for the condenser nozzle to provide a fine mist of liquid water through which the water vapor passes in order to enhance heat transfer. In order to create a spray pattern that enhances heat transfer, the condenser nozzles can provide an angle of spray of between about 10° and about 360°. In addition, condenser nozzles can be provided that create droplet sizes of between about 20 μm VMD and about 400 μm VMD.

The driver nozzles and the condenser nozzles are selected in order to provide a desired level of condensation in a desired time period. The driver nozzles can be selected to increase the flow of water vapor from the washing chamber interior into the water vapor recovery line. Because of the increased flow of water vapor, the condenser nozzles can be provided to increase the contact area between the liquid water and the water vapor to provide sufficient condensation of the water vapor. In general, it is desirable to remove the water vapor from the washing chamber interior as quickly as possible in order to minimize the delay between the end of the rinse cycle and the ability to remove articles from the washing chamber interior. The condenser nozzles are provided to increase the contact area (surface area) between water droplets and the water vapor. As the flow of water vapor is increased, the contact area should be increased to handle the desired level of heat transfer to condense a desired amount of the water vapor. The extent of the condensation of the water vapor will also depend on the temperature of the water vapor and the temperature of the liquid water used to condense the water vapor. The driver nozzles and the condenser nozzles can be selected in order take into account the desired speed in evacuating the washing chamber interior, the temperature of the condensation water, the temperature of the water vapor, and the desired level of condensing the water vapor.

The water vapor recovery line 70 can be characterized as a recirculation arrangement 71 because the water vapor and air mixture removed from the washing chamber interior is processed for the removal of water vapor, and the resulting drier water vapor and air mixture is returned to the washing chamber interior. The presence of the gap 60 can contribute to a certain level of replacement of the water vapor and air mixture inside the washing chamber interior with ambient air from outside the dishwashing machine 10.

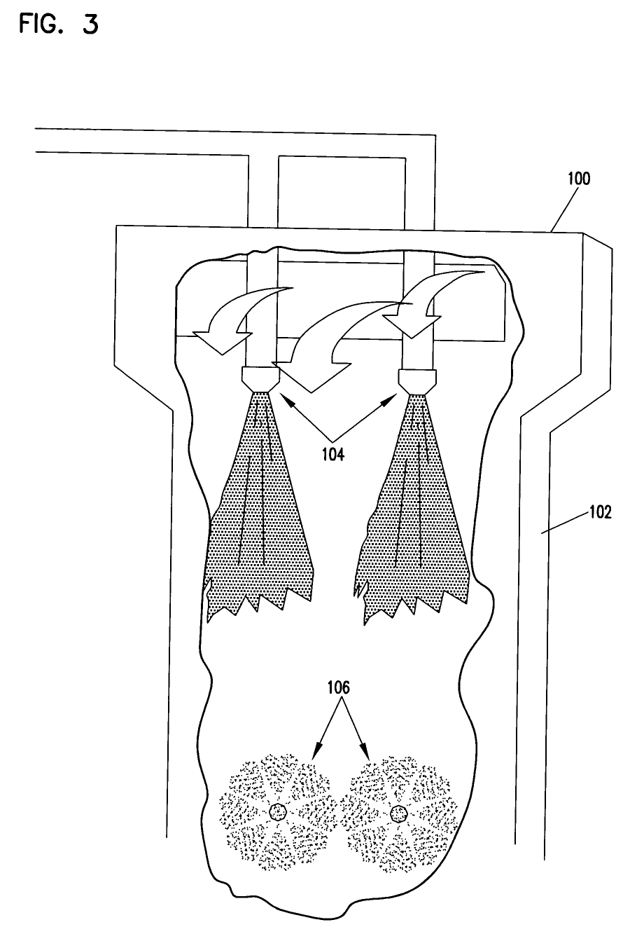

Now referring to FIG. 3, an alternative arrangement of a water vapor recovery line 100 is provided. The water vapor recovery line 100 is shown having a condensing region 102 that includes driver nozzles 104 and condenser nozzles 106. The driver nozzles 104 helps drive the flow of water vapor from the washing chamber interior through the vent 106 and into the condensing region 102. The condenser nozzles 106 are provided to increase the surface area of liquid water to help enhance the rate of condensation of the water vapor.

Although FIG. 3 shows the condenser nozzles 106 downstream of the driver nozzles 104, it should be understood that the arrangement can be reversed. That is, the condenser nozzles can be provided upstream of the driver nozzles. In addition, the arrangement can be staggered. That is, driver nozzles can be both upstream and downstream of the condenser nozzles, and vice versa. In addition, although the driver nozzles 104 are shown as a plurality of driver nozzles, a single driver nozzle can be provided. Similarly, although the condenser nozzles 106 are shown as a plurality of condenser nozzles, a single condenser nozzle can be provided. In addition, more than two of the driver nozzles and/or condenser nozzles can be provided. In general, it is desirable to select driver nozzles that provide the desired level of flow and condenser nozzles that provide the desired level of surface area across the flow area provided in the water vapor recovery line.

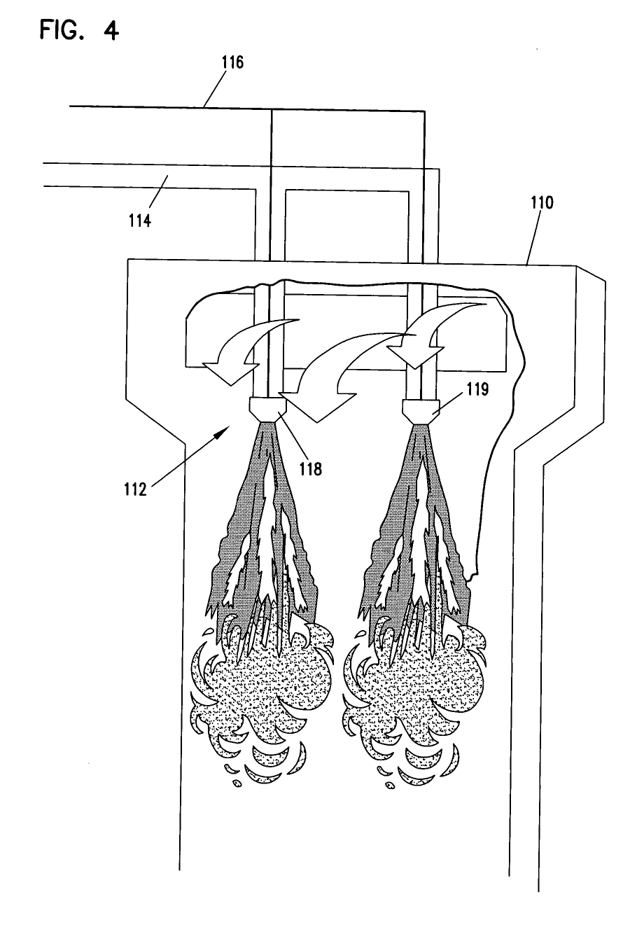

Now referring to FIG. 4, an alternative embodiment of a water vapor recovery line 110 is shown having a two phase nozzle arrangement 112 supplied by both a water line 114 and a pressurized air line 116. The two phase nozzle arrangement 112 can be provided as driver nozzles 118 and 119. The pressurized air line 116 can help create an increased liquid water surface area for contacting the water vapor and condensing the water vapor and it can help drive the water vapor out of the washing chamber interior and into the water vapor recovery line 110. Accordingly, the two phase nozzle arrangement 112 provides for driving the flow of water vapor and for condensing the water vapor. It is believed that by using a two phase nozzle arrangement 112, increases in both water vapor flow and contact area can be achieved.

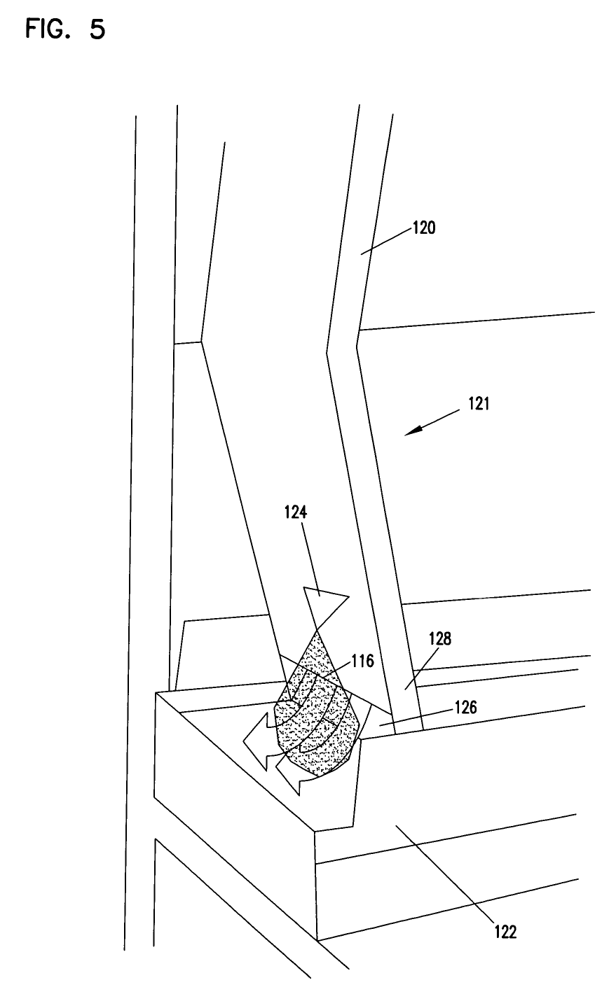

Now referring to FIG. 5, an alternative arrangement of the water vapor recovery line is shown at reference numeral 120. The water vapor recovery line 120 can be characterized as a replacement arrangement 121 because the water vapor and air mixture recovered from the washing chamber interior is processed for the condensation of water vapor and the resulting drier water vapor and air mixture is vented to the environment. That is, the drier water vapor and air mixture is not recirculated back to the dishwashing machine. It should be understood that the two phase nozzle arrangement 112 shown in FIG. 4 may be advantageously used in the replacement arrangement 121 because the pressurized air line 116 adds additional air to the water vapor and air mixture.

The water vapor recovery line 120 is constructed so that condensate drains to a dish machine drain pan 122 rather than being recycled. Although certain embodiments of the invention show a recycle of the condensate and the water spray, it should be understood that the recycle can be avoided and the condensate and water spray can be discharged to a drain. The water vapor recovery line 120 can include an external nozzle 124 that is provided to help condense water vapor that may be exiting the water vapor recovery line 120. The external nozzle 124 can be constructed as a condenser nozzle to provide a spray pattern 116 that covers at least a portion of the opening 126 at the water vapor recovery line exit 128. The spray pattern 116 can be provided so that it flows into the dish machine drain pan 122. The purpose of the external nozzle 124 is to help reduce water vapor from exiting the water vapor recovery line 120.

By providing the external nozzle 124 outside of the water vapor recovery line 120, it is expected that the water vapor recovery line 120 will be less likely to heat the water spray from the external nozzle 124. As a result, the water spray from the external nozzle 124 may be cooler than it would be if it were inside the water vapor recovery line 120. In addition, the external nozzle 124 can be selected to provide a spray having any desired shape, such as, circular or rectangular to cover the air flow across the opening 126.

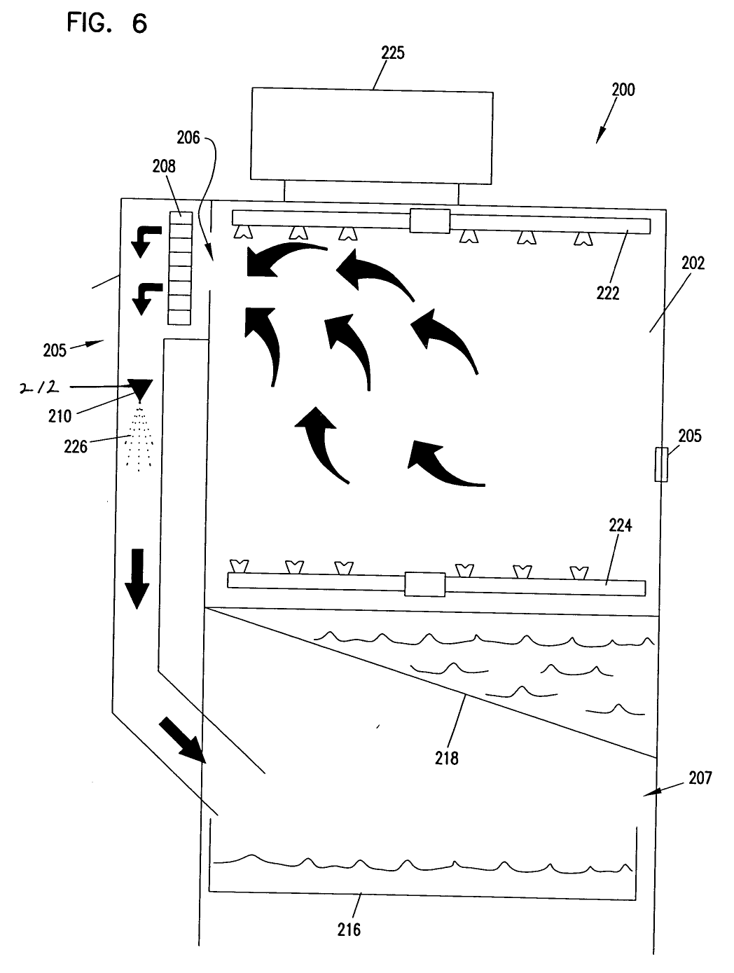

Now referring to FIG. 6, a dishwashing machine 200 is shown having a washing chamber interior 202 and a water vapor recovery line 204. The water vapor recovery line 204 can be characterized as a replacement arrangement 205 because the water vapor and air mixture from inside the washing chamber interior 202 is removed, processed through the water vapor recovery line 204, and vented to the atmosphere 207 and drain pan 216 rather than being returned to the dishmachine tank 218. A series of replacement air vents 205 can be provided to allow ambient air to enter into the washing chamber interior 202 as the water vapor and air mixture from inside the washing chamber interior 202 is removed through the vent 206. The vent 206 is provided between the washing chamber interior 202 and the water vapor recovery line 204 to allow the water vapor to flow from the washing chamber interior 202 to the water vapor recovery line 204. A fan 208 can be provided to help draw the water vapor out of the washing chamber interior 202 and into the water vapor recovery line 204. The fan 208 is shown provided within the water vapor recovery line 204 adjacent to the vent 206. It should be understood that the fan 208 can be provided within the washing chamber interior 202 on the other side of the vent 206. In addition, the fan 208 can be provided further downstream in the water vapor recovery line 204.

The water vapor recovery line 204 includes a spray nozzle arrangement 210 for condensing the water vapor. The spray nozzle arrangement 210 can be provided as a condenser nozzle 212 in order to increase the rate of condensation. The fan can be used to increase the water vapor flow through the water vapor recovery line 204. By increasing the water vapor flow, it is expected that the water vapor will be drawn out of the wash chamber interior 202 quickly. In addition, by utilizing a fan to drive the water vapor flow, it is possible that driver nozzles can be avoided in favor of condenser nozzles to increase heat transfer and the rate of condensation. In addition, by avoiding the use of driver nozzles, it is possible to decrease the amount of water used to condense the water vapor.

The resulting condensed water vapor can be delivered to a drain pan 216 as shown, or the condensed water can be recycled to the dishmachine tank 218. The fan 208 can be operated to provide the desired level of flow of water vapor out of the washing chamber interior 202. In general, it is expected that the fan should be capable of providing a flow rate of between about 45 ft³/min and about 130 ft³/min, and between about 45 ft³/min and about 60 ft³/min.

Once the spray arms 222 and 224 stop delivering rinse water to articles provided within the washing chamber interior 202, the fan 208 can be operated to draw the water vapor out of the washing chamber interior 202, in the direction of the arrows, through the vent 206 and into the water vapor recovery line 204. The spray nozzle arrangement 210 can provide a water spray 226 that condenses the water vapor and the resulting condensed water vapor can flow into the drain pan 216. A controller 225 can be used to control the operation of the dishwashing machine 200.

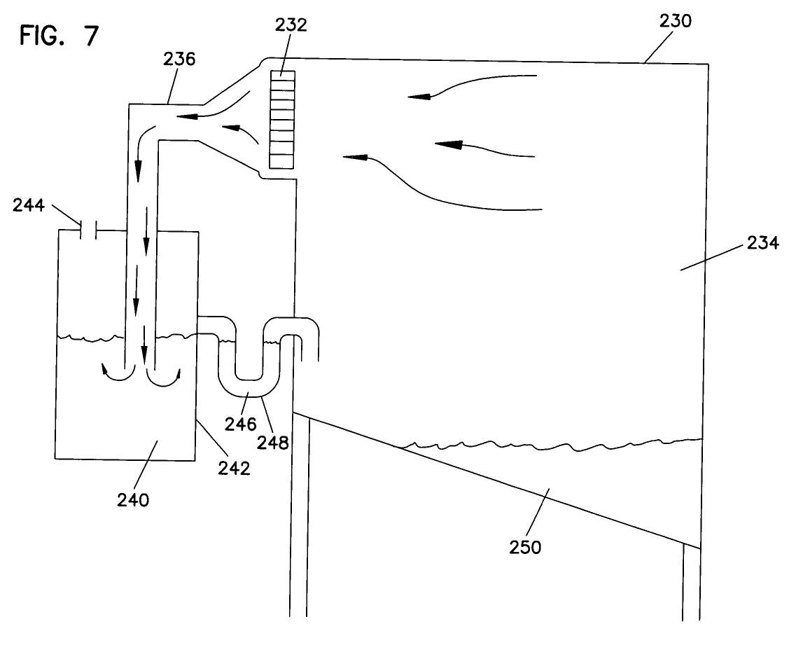

Now referring to FIG. 7, a dishwashing machine 230 is shown having a fan 232 for fan assisted removal of water vapor from the washing chamber interior 234 into the water vapor recovery line 236. The fan 232 causes the water vapor to flow into a water bath 240. The water vapor condenses as it contacts the water bath 240. The water bath tank 242 includes a tank vent 244 for allowing air to flow out of the water bath tank 242 so that the water bath tank 242 is provided at atmospheric pressure. A condensed water conduit 246 can be provided between the water bath tank 242 and the dishmachine tank 250 to allow condensed water to flow from the water bath tank 242 into the dishmachine tank 250. A trap 248 can be provided in the condensed water conduit 246 to prevent the atmosphere within the washing chamber interior 234 from escaping into the atmosphere without passing through the water vapor recovery line 236. In addition, the dishwashing machine 200 can be provided without the condensed water conduit 246 connecting the water bath tank 242 to the washing chamber interior 234.

It is believed that the bath 240 provides a large amount of contact area between the water and the water vapor to provide a desired level of condensation. Controls can be provided so that the water level and temperature are kept within desired limits. When the water level gets too high or too low or if the temperature of the water bath 240 becomes too high, the water bath tank 242 can be dumped and refilled or additional cooling water can be added. Cool water can be added as make-up water to keep the water temperature within the desired range.

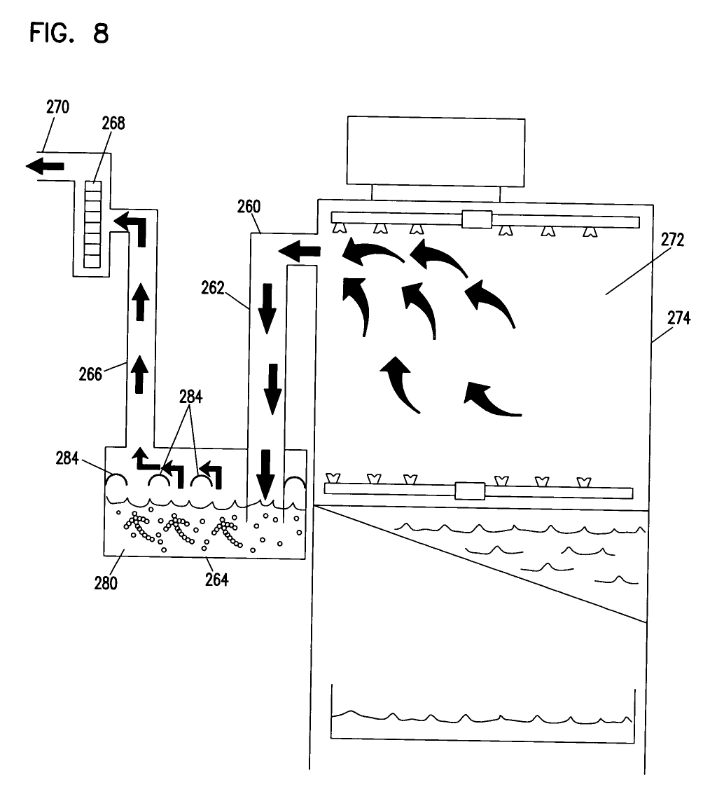

Now referring to FIG. 8, an alternative design of a water vapor recovery line is shown at reference numeral 260. The water vapor recovery line 260 includes a water vapor line 262, a condensation tank 264, an air line 266, and a fan 268 for pulling air through the air line 266 to the dry air outlet 270. By operating the fan 268, air is drawn through the air line 266. As a result, a vacuum can be created within the condensation tank 264 that pulls water vapor from the washing chamber interior 272 from the dishwashing machine 274, through the vent 276 and into the water vapor line 262. As the water vapor 272 enters the water bath 280 provided within the condensation tank 264, the water vapor condenses. The resulting air is then removed through the air line 266. The condensed water accumulates within the condensation tank 264. As the temperature of the water bath 280 increases, cooler water can be added or at least a portion of the water bath can be drained and refilled with cooler water. In addition, as the level of the water bath 280 increases to a level that is too high, at least a portion of the water bath can be drained.

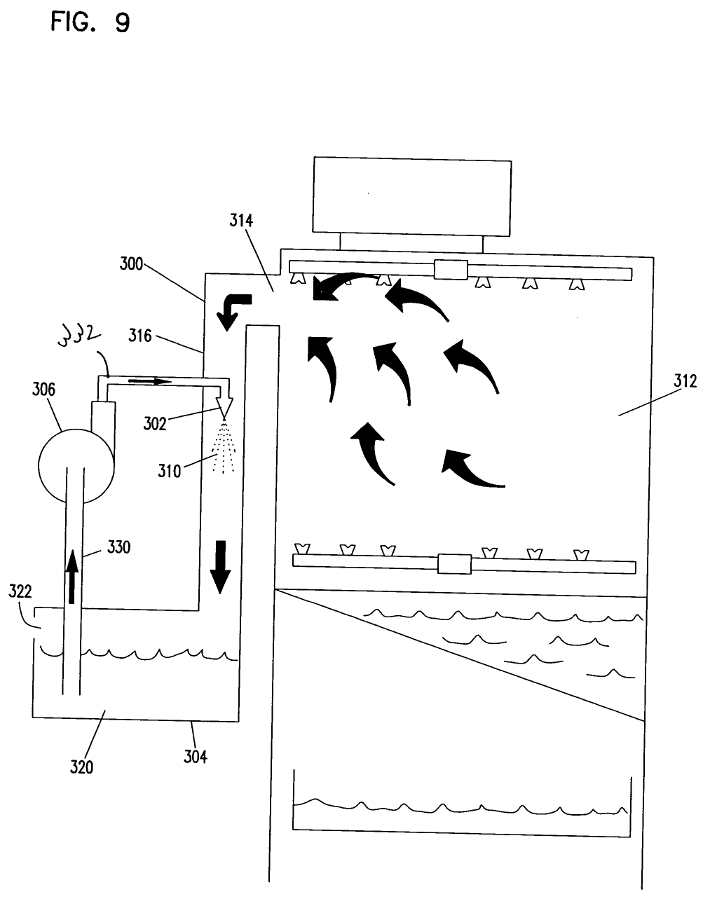

An alternative water vapor recovery line is shown at reference numeral 300 in FIG. 9. The water vapor recovery line 300 includes a spray nozzle arrangement 302, a condensate recovery tank 304, and a recycle pump 306. As a result of the spray nozzle arrangement 302 creating a spray pattern 310, water vapor is drawn from the washing chamber interior 312 through the vent 314 and into the water vapor line 316. Water vapor within the water vapor line 316 condenses and flows into the water bath 320 provided in the water bath collection tank 304. The water bath collection tank 304 includes a vent 322 that allows the water bath collection tank 304 to remain at atmospheric pressure. When the recycle pump 306 is operated, water is drawn from the water bath 320 via the uptake line 330 and through the delivery line 332 to the spray nozzle arrangement 302.

The spray nozzle arrangement 302 can be provided as a plurality of spray nozzles and can include driver nozzles and condenser nozzles as described earlier. The representation of a single nozzle is provided for convenience. By recycling the water that is condensed, it is believed that less water can be used. It is expected that the water may be allowed to sit in the water bath collection tank 304 and cool.

The above specification provides a complete description of the manufacture and use of the apparatus according to the invention. Since many embodiments of the invention can be made without departing from the spirit and scope of the invention, the invention resides in the claims hereinafter appended.

We claim:

1. A dishwashing machine comprising:
(a) a washing chamber comprising a housing, a washing chamber interior for spray application of wash water and rinse water, and a water vapor vent for removal of water vapor from the washing chamber interior;
(b) a water holding tank for holding wash water and rinse water; and
(c) a water vapor recovery line extending from the water vapor vent to an air and liquid water discharge, the water vapor recovery line comprising a condensing region for condensing water vapor present in the condensing region, the condensing region comprising a plurality of spray nozzles for spraying water within the condensing region.

2. A dishwashing machine according to claim 1, wherein the air and liquid water discharge is constructed to convey liquid water to the water holding tank.

3. A dishwashing machine according to claim 1, wherein the air and liquid water discharge is constructed to convey liquid water to a drain.

4. A dishwashing machine according to claim 1, further comprising a fan constructed to draw water from the washing chamber interior into the condensing region.

5. A dishwashing machine according to claim 4, wherein the fan is provided in the water vapor recovery line.

6. A dishwashing machine according to claim 1, wherein the plurality of spray nozzles comprises a first set of spray nozzles and a second set of spray nozzles, wherein the second set of spray nozzles is provided downstream of the first set of spray nozzles.

7. A dishwashing machine according to claim 6, wherein the first set of spray nozzles generate a spray pattern having a spray angle of between about 20° and about 90°.

8. A dishwashing machine according to claim 6, wherein the second set of spray nozzles provide a spray pattern having a spray angle of between about 10° and about 360°.

9. A dishwashing machine according to claim 1, wherein the plurality of spray nozzles comprises at least one spray nozzle that sprays water under compressed air.

10. A dishwashing machine according to claim 1, wherein the water vapor recovery line comprises at least one exterior spray nozzle located outside the water vapor conduit at the air and liquid water discharge for spraying water to condense water vapor.

11. A dishwashing machine according to claim 1, wherein the housing comprises an air vent for allowing flow of air from outside the housing into the washing chamber interior.

12. A dishwashing machine according to claim 1, wherein the air and liquid water discharge is constructed to convey liquid water to a recycle tank.

13. A dishwashing machine according to claim 12, further comprising a recycle pump for conveying water from the recycle tank to the plurality of spray nozzles.

14. A dishwashing machine comprising:
(a) a washing chamber comprising a housing, a washing chamber interior for spray application of wash water and rinse water, and a water vapor vent for removal of water vapor from the washing chamber interior;
(b) a water holding tank for holding wash water and rinse water; and
(c) a water vapor recovery line comprising:
(i) a water tank comprising a water bath;
(ii) a water vapor conduit comprising a first end and a second end, the first end extending from the water vapor vent and the second end provided in the pool of water; and
(iii) an air discharge from the water tank; and
(iv) a fan for drawing water vapor from the washing chamber interior to the water holding tank.

15. A dishwashing machine according to claim 14, wherein the water vapor recovery line comprises a fan for conveying water vapor from the washing chamber interior into the pool of water.

16. A dishwashing machine according to claim 14, wherein the water tank comprises an air conduit for venting the water tank.

17. A dishwashing machine according to claim 16, wherein the air conduit comprises a fan for exhausting air from the water tank.

18. A dishwashing machine according to claim 14, wherein the water vapor recovery line further comprises a recycle conduit for conveying water from the water tank to the water holding tank.

19. A dishwashing machine according to claim 18, wherein the recycle conduit comprises a water trap for reducing flow of air between the washing chamber interior and the water tank.

20. A method for operating a dishwashing machine comprising:
(a) washing articles in a washing chamber interior of a washing chamber by spray application of wash water and rinse water onto the articles;
(b) drawing water vapor from the washing chamber interior into a water vapor recovery line at a volume flow rate of at least about 45 ft³/min, and condensing at least a portion of the water vapor to provide condensed water;
(c) removing the articles from the washing chamber interior.

21. A method according to claim 20, wherein the step of drawing water vapor from the washing chamber interior into the water vapor recovery line comprises drawing water vapor at a volume flow rate of between about 45 ft³/min and about 130 ft³/min

22. A method according to claim 20, further comprising a step of:
(a) recycling at least a portion of the condensed water to a water holding tank in the dishwashing machine.

23. A method according to claim 20, further comprising a step of:
(a) allowing at least a portion of the condensed water to flow to a drain pan.

24. A method according to claim 20, wherein the step of drawing water vapor occurs for a time period of between about 10 seconds and about 40 seconds.

25. A method according to claim 20, wherein the step of drawing water vapor comprises using a fan to draw the water vapor.

26. A method according to claim 25, further comprising drawing the water vapor into a water bath.

27. A method according to claim 20, wherein the step of drawing vapor comprises spraying water in the water vapor recovery line to draw water vapor from the washing chamber interior.

28. A dishwashing machine comprising:
(a) a washing chamber comprising a housing, a washing chamber interior for spray application of wash water and rinse water, and a water vapor vent for removal of water vapor from the washing chamber interior;
(b) a water holding tank for holding wash water and rinse water; and
(c) a water vapor recovery line comprising:
(i) a water vapor conduit in communication with the washing chamber vent and comprising a condensing region for condensing water vapor present in the condensing region, the condensing region comprising a spray nozzle arrangement for spraying water within the condensing region to create a water vapor flow rate of at least about 45 ft³/min; and
(ii) an air and liquid water discharge.
